(19) United States
(12) Patent Application Publication
(10) Pub. No.: US 2015/0252827 A1
(43) Pub. Date: Sep. 10, 2015

(54) TOOL SUSPENSION DEVICE

(71) Applicant: Yu-Hua OU, Taichung (TW)

(72) Inventor: Yu-Hua OU, Taichung (TW)

(21) Appl. No.: 14/196,080

(22) Filed: Mar. 4, 2014

(51) Int. Cl. F16B 5/00; B25H 3/04

(52) U.S. Cl. CPC F16B 5/0012; B25H 3/04

(57) ABSTRACT

A tool suspension device includes a main body having a front face, a rear face, and plural lateral faces. The main body has a suspension portion and has a tool receiving portion for receiving tools. The main body has at least one male engaging portion and at least one female engaging portion located at two opposite sides of the main body. The male engaging portion has a shape corresponding to the one of the female engaging portion. Thus, the tool suspension device can be engaged with another tool suspension device by engaging the male engaging portion and the female engaging portion together.

### BACKGROUND OF THE INVENTION

1. Field of the Invention

The present invention relates to a tool suspension device which is easy to be assembled with other ones.

2. Description of the Prior Art

A conventional tool suspension device, as disclosed in patents TW M454911, TW M435978, and TW 1409150, usually includes a board-shaped seat which is formed with a suspension hole or other suspension means on the top thereof. The seat is also formed with polygonal protrusions, hooks, or other tool positioning means.

However, when plural tool suspension devices have to be displayed at the same time, the object for suspension must have plural holes or hooks for the tool suspension devices to hang on so as to be inconvenient. Besides, plural tool suspension devices are difficult to restored and may be easily lost.

### SUMMARY OF THE INVENTION

The main object of the present invention is to provide tool suspension device having engagement mechanism to be engaged with other tool suspension devices.

To achieve the above and other objects, the tool suspension device of the present invention includes a main body having a front face, a rear face, and a plurality of lateral faces. The main body has a suspension portion. The main body has at least one tool receiving portion on the front face for receiving tools. The main body further has at least one male engaging portion and at least one female engaging portion. The male engaging portion and the female engaging portion has shapes corresponding to each other. The male engaging portion is adapted for being engaged with a female engaging portion of another tool suspension device. The female engaging portion is adapted for being engaged with a male engaging portion of another tool suspension device. Thereby, the tool suspension device is able to be engaged with other same ones for multiple uses.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of the present invention;

FIG. 2 is an illustration of the present invention;

FIG. 3 is a front view of the present invention.

### DETAILED DESCRIPTION OF THE PREFERRED EMBODIMENTS

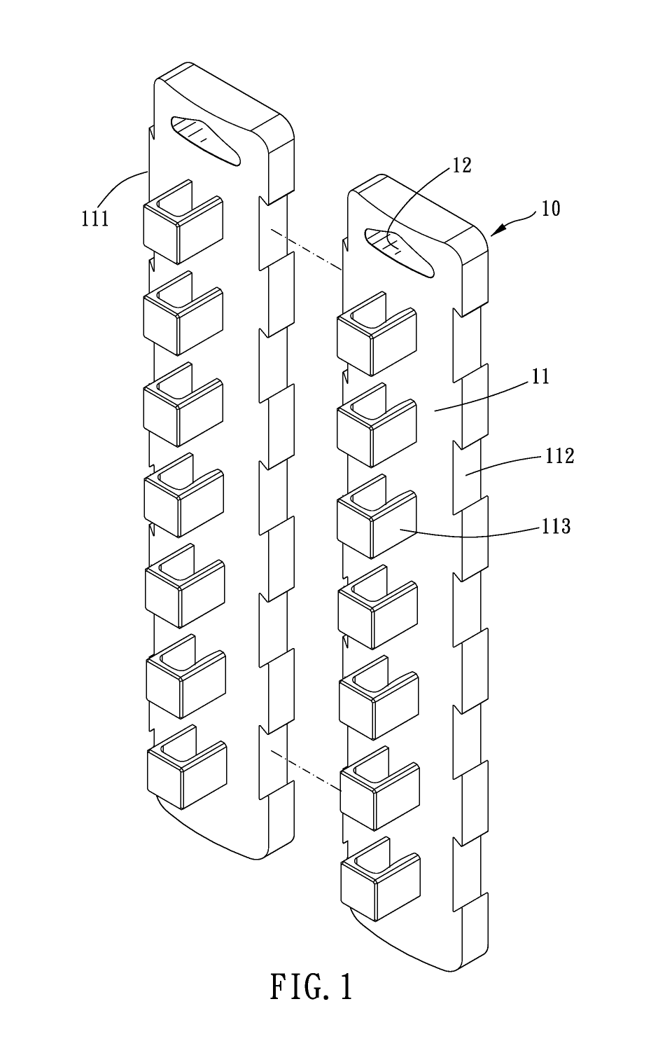

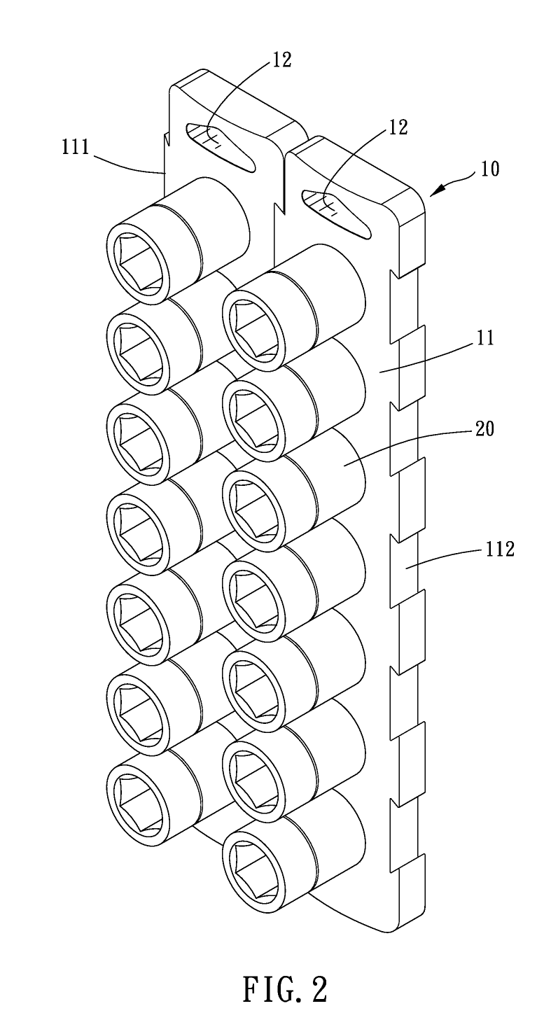

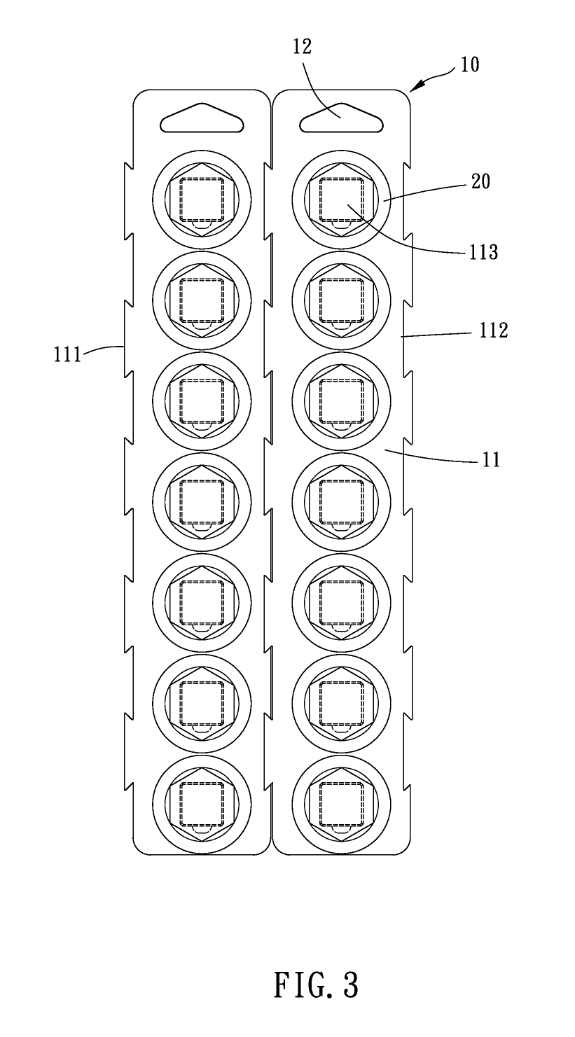

Please refer to FIG. 1 to FIG. 3, the tool suspension device of the present invention includes a main body 10. The main body 10 has a front face 11, a rear face, and a plurality of lateral faces. More specifically, the main body 10 is substantially rectangle board-shaped and has two short edges and two long edges. The main body 10 has a suspension portion 12 such as a suspension hole for suspending on a hook. The suspension hole penetrates the front face 11 and the rear face. In other possible embodiments, the suspension portion can be a hook, a magnet, a clip, or other structures. The main body 10 further has at least one tool receiving portion 113 for receiving tools. In the present embodiment, the tool receiving portion 113 is a polygonal protrusion to correspond to a polygonal hole of a socket 20. However, the tool receiving portion can be formed in other forms, such as a hook. The main body 10 further has at least one male engaging portion and at least one female engaging portion located at two opposite lateral faces of the main body 10. The male engaging portion has a shape complementary to the female engaging portion. The male engaging portion is adapted for a female engaging portion of another tool suspension device to engage with. The female engaging portion is adapted for a male engaging portion of another tool suspension device to engage with. In the major embodiment, the male engaging portion and the female engaging portion are located at the two long edges respectively. The male engaging portion includes a plurality of engaging bumps 111 arranged spacedly, and the female engaging portion includes a plurality of recesses 112 arranged spacedly. Each engaging bump 111 has a shape complementary to the one of each recess 112. In the present embodiment, width of each engaging bump 111 is increased from the bottom toward the free end thereof to be dove-tail-shaped. Width of each recess 112 is tapered from the bottom toward the opening thereof to be dove-tail-shaped. The engaging bumps 111 and the recesses 112 are aligned along the long edges. By engaging the male engaging portions and the female engaging portions of plural tool suspension devices, the tool suspension devices are assembled as a single piece. In other possible embodiments, the male engaging portion and the female engaging portion can be formed as shapes of jigsaw or building blocks.

Practically, the tool suspension device can be used, sold, or displayed alone. Also, plural of tool suspension devices can be assembled as an integrate piece for displaying. For example, if plural tool suspension devices receiving plural kinds of tool have to be displayed but there is only one hook for hanging them, one can assemble the tool suspension devices first, and then hang them with the suspension portion of one of the tool suspension devices. Thus, the tool suspension devices can be displayed at the same time. On the other hand, plural tool suspension devices assembled are easier to be restored or transported.

In the major embodiment of the present invention, the suspension portion is located at the top of the main body, and the male engaging portion and the female engaging portion are located at the left side and the right side of the main body and are arranged vertically. Thereby, when plural tool suspension devices are assembled one by one, better vertical support can be provided due to the engagement between the male engaging portion and the female engaging portion. Thus, the tool suspension devices may not be disassembled by gravity. As a result, only the suspension portion of one of the tool suspension devices has to be hung for positioning.

In other possible embodiments, the female engaging portion (or the male engaging portion) can be adapted for the male engaging portions (or female engaging portions) of plural tool suspension devices to engage with at the same time. Thus, the present invention can be assembled in kinds of manner.

What is claimed is:

1. A tool suspension device, including:
a main body, having a front face, a rear face, and a plurality of lateral faces, the main body having a suspension portion, the main body having at least one tool receiving portion on the front face, the main body having at least one male engaging portion and at least one female engaging portion which are located at two opposite lateral faces of the main body respectively, the male engaging portion and the female engaging portion having shapes complementary to each other, the male engaging portion being adapted for a female engaging portion of another tool suspension device to engage, the female engaging portion being adapted for a male engaging portion of another tool suspension device to engage.

2. The tool suspension device of claim 1, wherein the main body is rectangle board-shaped and has two shorter lateral faces and two longer lateral faces, the male engaging portion and the female engaging portion are located on the two longer lateral faces respectively.

3. The tool suspension device of claim 1, wherein the suspension portion includes a suspension hole penetrating the front face and the rear face of the main body.

4. The tool suspension device of claim 1, wherein the male engaging portion includes a plurality of engaging bumps arranged spacedly, the female engaging portion includes a plurality of recesses arranged spacedly, each engaging bump and each recess have shapes complementary to each other.

5. The tool suspension device of claim 4, wherein widths of each engaging bump increase from a base toward a free end of the engaging bump so that the engaging bump is dove-tail-shaped, widths of each recess is tapered from a bottom toward an opening of the recess so that the recess is dove-tail-shaped.

6. The tool suspension device of claim 1, wherein the tool receiving portion includes a polygonal protrusion.
